(19) United States
(12) Patent Application Publication
(10) Pub. No.: US 2015/0303559 A1
(43) Pub. Date: Oct. 22, 2015

(54) OSCILLATION DEVICE, RECEPTION DEVICE AND SAMPLE INFORMATION ACQUISITION APPARATUS

(71) Applicant: CANON KABUSHIKI KAISHA, Tokyo (JP)

(72) Inventor: Yoshinori Tateishi, Naka-gun (JP)

(21) Appl. No.: 14/387,152

(22) PCT Filed: Apr. 19, 2013
(86) PCT No.: PCT/JP2013/062308

§ 371 Date: Sep. 22, 2014

(30) Foreign Application Priority Data
May 10, 2012 (JP) 2012-108683

(51) Int. Cl. H01Q 1/50; H04B 1/16; H01Q 13/00

(52) U.S. Cl. CPC H01Q 1/50; H01Q 13/00; H04B 1/16

(57) ABSTRACT

An oscillation device 100 for electromagnetic wave oscillation includes: a resonator section 101 that causes an electromagnetic wave to resonate; and an antenna section 102 that is arranged at an end facet of the resonator section 101 and has a multilayer structure including two conductor layers 104 and 105 for causing the electromagnetic wave to be emitted the from the resonator section 101, the two conductor layers 104 and 105 being separated from each other by a gap in the stacking direction of the multilayer structure and having a at least partly overlapping matching area 110 for impedance matching; the matching area 110 having a tapered profile of being tapered in the extending direction thereof from the resonator section 101 toward the antenna section 102 as viewed in the stacking direction.

### TECHNICAL FIELD

This invention relates to an oscillation device, a reception device and a sample information acquisition apparatus. More particularly, the present invention relates to an optical device such as an oscillation device that includes a waveguide for electromagnetic waves in the frequency range from the millimeter wave band to the terahertz wave band (from 30 GHz to 30 THz), which the electromagnetic waves are also referred to as terahertz waves hereinafter, and generates such electromagnetic waves.

### BACKGROUND ART

Various organic molecules of biomaterials, medicinal drugs, electronic materials and other materials have an absorption peak in the frequency range of terahertz waves that derives from the structure and/or the state of the material. Terahertz waves represent a high transmissivity relative to various materials such as paper, ceramics, resins and cloths. In recent years, research and development efforts have been paid in the field of imaging technologies and sensing technologies to exploit the characteristic features of terahertz waves. For example, such technologies are expected to find applications in the field of examination apparatus for seeing through the object of examination that can replace X-ray apparatus and non-destructive examination apparatus that can be used in manufacture lines.

Applications of semiconductor quantum well structures that utilize gains of electromagnetic waves based on intersubband transitions of electrons to current injection type terahertz wave sources are being discussed. NPL 1 listed below proposes a quantum cascade laser (QCL) using a terahertz wave band that is formed by integrally combining a double-side metal waveguide (to be also referred to as DMW hereinafter), which is known as low loss waveguide, as resonator. This device can achieve laser oscillations at and near 3 THz due to high light confinement effects and low loss propagation by causing the resonator structure in which metals are arranged above and below a gain medium formed of a semiconductor thin film having a thickness of about 10 μm to guide terahertz waves produced by stimulated emission in a surface plasmon mode.

### CITATION LIST

### Patent Literature

PTL 1: Jpn. PCT National Publication No. 2010-510703
PTL 2: U.S. Patent Publication No. 2007/0116420

### Non Patent Literature

NPL 1: Appl. Phys. Lett. 83, 2124 (2003)
NPL 2: OPTICS LETTERS, VOL. 32, ISSUE 19, PP. 2840-2842 (2007)

### SUMMARY OF INVENTION

### Technical Problem

DMW have a problem to be solved of how to efficiently utilize and easily handle electromagnetic waves because there arises an increase in the end facet reflection that is caused by mode mismatching between the waveguide and the space. With regard to this problem, NPL 2 proposes a technique of improving the efficiency of taking out electromagnetic waves and the directivity by arranging a silicon lens at an end of the waveguide. However, this technique is far from providing mechanical stability and requires additional members including a silicon lens to easily push up the cost. PTL 1 discloses an arrangement of integrally combining a horn antenna for use. However, this arrangement is also far from providing mechanical stability and involves a complex manufacturing process because the antenna portion thereof has a three-dimensional structure. Finally, PTL 2 discloses a technique of arranging electrodes partly in an overlapped manner in the resonance region (standing wave region). However, such an overlapping area is neither found in the antenna section connected to the resonance section nor related to impedance matching.

### Solution to Problem

In view of the above-identified problems of the prior art, in an aspect of the present invention, there is provided an oscillation device for electromagnetic wave oscillation including:

a resonator section that causes an electromagnetic wave to resonate; and
an antenna section that is arranged at an end facet of the resonator section and has a multilayer structure including two conductor layers for causing the electromagnetic wave to be emitted from the resonator section,
the two conductor layers being separated from each other by a gap in the stacking direction of the multilayer structure and having a at least partly overlapping matching area for impedance matching,
the matching area having a tapered profile of being tapered in the extending direction thereof from the resonator section toward the antenna section as viewed in the stacking direction.

Thus, an oscillation device in this aspect of the present invention has a tapered matching area arranged at the resonator section side of the antenna section that is connected to the resonator section for causing an electromagnetic wave to resonate. The input impedance of the antenna section can be adjusted by adjusting the size and the contour of the matching area. For instance, the characteristic impedance of the resonator section and the input impedance of the antenna section may be made to be close to each other for impedance matching. Furthermore, the matching area can be made to represent a tapered profile in the extending direction thereof from the resonator section toward the antenna section and additionally forming an aperture antenna in the two conductor layers to establish matching with the outside of the device such as a free space.

Further features of the present invention will become apparent from the following description of exemplary embodiments with reference to the attached drawings.

### BRIEF DESCRIPTION OF DRAWINGS

FIG. 1 is a schematic perspective view of an embodiment of device according to the present invention.

FIGS. 2A, 2B and 2C are a top view and cross-sectional views of the embodiment of device according to the present invention.

FIGS. 3A, 3B and 3C are enlarged schematic top views of the embodiment of device according to the present invention.

FIG. 4 is a graph illustrating the results of computations for the output of the embodiment of oscillation device according to the present invention.

FIG. 5 is a schematic perspective view of the device of Example 1 of the present invention.

FIG. 6 is another schematic top view of the device according to Example 1 of the present invention.

FIG. 7 is a schematic perspective view of the device according to Example 2 of the present invention.

FIG. 8 is a schematic illustration of a measuring apparatus formed by using a device according to the present invention.

### DESCRIPTION OF EMBODIMENTS

An oscillation device according to the present invention is characterized in that the oscillation device includes an antenna section connected to a resonator section and the antenna section has two conductor layers that have a at least partly overlapping matching area for impedance matching, the matching area having a tapered profile of being tapered in the extending direction thereof from the resonator section toward the antenna section as viewed in the stacking direction of the conductor layers. The resonator section typically has a structure of using a DMW that has a gain medium having a gain relative to an electromagnetic wave between the first and second conductor layers as resonator. The antenna section typically has third and fourth conductor layers respectively electrically connected to the first and second conductor layers in the parts of the resonator section through which an electromagnetic wave enters and exits. In the matching area, the third conductor layer and the fourth conductor layer are so arranged as to at least partly overlap each other with a gain medium or an insulator such as a dielectric interposed between them in order to suppress reflections of electromagnetic waves at the interface of the resonator section and the antenna section. The input impedance of the antenna section can be appropriately adjusted by adjusting the size and the contour of the matching area. Matching with the outside of the device such as a free space can be established by forming an aperture antenna both in the third and fourth conductor layers. In this way, an oscillation device and any others that can efficiently utilize electromagnetic waves in the frequency range of not lower than 30 GHz and not higher than 30 THz in the resonator section can be obtained. The two conductor layers of the antenna section may be made to partly overlap each other as in the instances of the embodiments and the examples that are described hereinafter. Alternatively, the tapered two conductor layers may be made to completely overlap each other. Still alternatively, one of the tapered conductor layers may made to completely overlap part of the other tapered conductor layer. Unlike the structure described in PTL 2, the antenna section of an oscillation device according to the present invention can efficiently take out electromagnetic waves without having a resonance feature.

Now, the present invention will be described in greater detail below by referring to the accompanying drawings that schematically illustrate embodiments and examples of the present invention.

### Embodiment

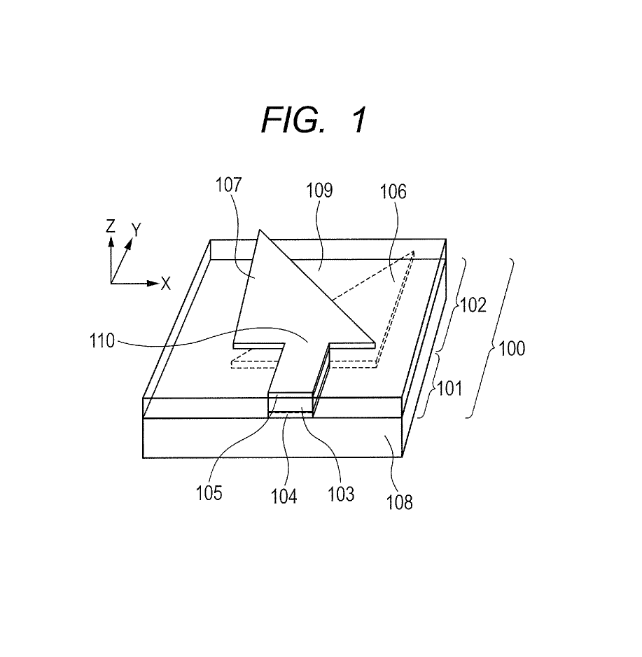

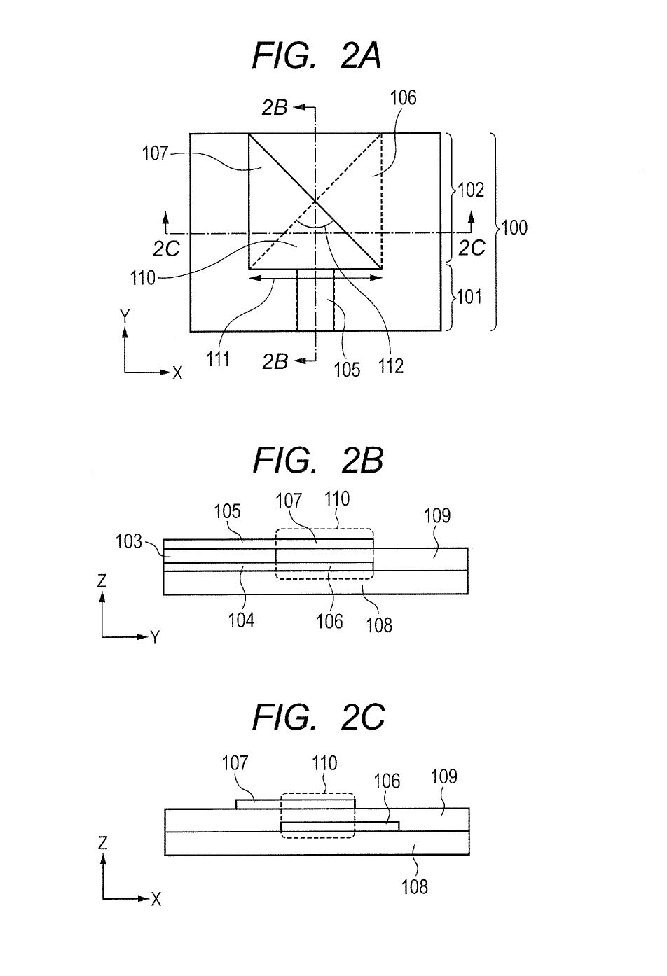

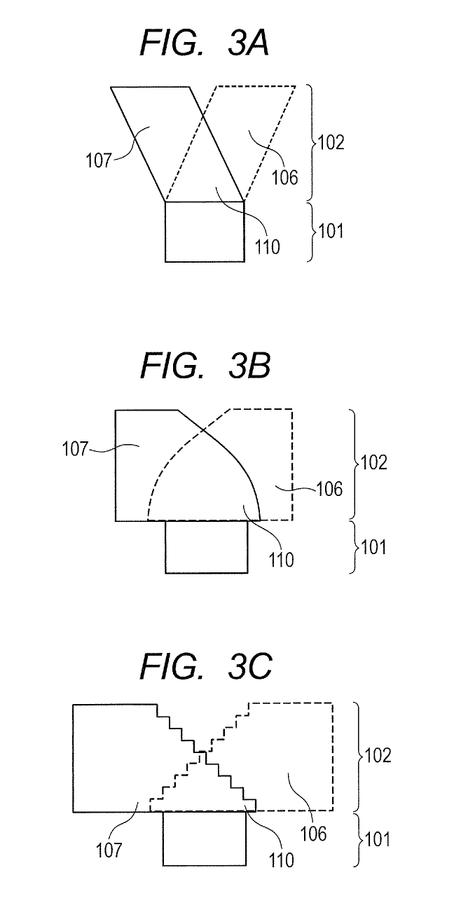

An embodiment of oscillation device according to the present invention will be described below by referring to FIGS. 1, 2A through 2C and 3A through 3C. FIG. 1 is a schematic perspective view of the oscillation device 100, representing how it appears. FIG. 2A is a schematic top view of the oscillation device 100 and FIGS. 2B and 2C are schematic cross sectional views of the oscillation device 100 respectively taken along line 2B-2B in FIG. 2A and line 2C-2C in FIG. 2A in FIG. 2A. FIGS. 3A through 3C are schematic top views of the matching areas 110 of different antenna sections obtained by modifying the antenna section 102 of the embodiment.

The oscillation device 100 of this embodiment includes a resonator section 101 and an antenna section 102. The resonator section 101 includes an active layer 103, a first conductor layer 104 and a second conductor layer 105. The antenna section 102 includes a third conductor layer 106 and a fourth conductor layer 107. The resonator section 101 is laid on a substrate 108 and an interlayer insulation film 109 is arranged at the lateral sides of the resonator section 101. The resonator section 101 is a plasmon waveguide generally referred to as DMW and has a structure where the active layer 103, which operates as core, is sandwiched between the two closely arranged conductor plates of the first conductor layer 104 and the second conductor layer 105, which operate as clads. Thus, the plasmon waveguide structure is formed by the first conductor layer and the second conductor layer of the resonator section and the real part of dielectric constant thereof includes a negative dielectric constant medium.

The active layer 103 includes a semiconductor section having a multiple quantum well structure that generates terahertz waves by way of intersubband transitions of carriers and has an electromagnetic gain in the terahertz wave frequency range. For instance, the active layer 103 may suitably be made to have a resonance tunnel structure formed by tens of layers of semiconductor multilayer films or a quantum cascade laser structure formed by hundreds to thousands of layers of semiconductor multilayer films. In this embodiment, a resonance tunnel diode (to be also referred to as RTD hereinafter) is employed for the active layer 103. RTD has an electromagnetic gain in a frequency range extending from millimeter waves to terahertz waves that is based on a photon assisted tunneling phenomenon in a negative differential resistance area. The active layer 103 may be provided with a densely doped semiconductor layer for the purpose of connecting the semiconductor section having a multiple quantum well structure to the first conductor layer 104 and the second conductor layer 105. The direction of stacking the layers is defined by the active layer 103 having the above-described multilayer structure.

The active layer 103 is connected to the first conductor layer 104 and the second conductor layer 105 electrically and mechanically. The oscillation device 100 is so configured as to apply a bias voltage to the RTD of the active layer 103 by applying a bias voltage between the first conductor layer 104 and the second conductor layer 105 from an external power source. Examples of suitable materials for forming the first conductor layer 104 and the second conductor layer 105 include metals (such as Ag, Au, Cu, Al and AuIn alloy), semimetals (such as Bi, Sb, ITO and ErAs) and densely doped semiconductors.

The oscillation device 100 of this embodiment includes an antenna section 102 including a third conductor layer 106 and a fourth conductor layer 107 arranged at an end facet of the resonator section 101 that emits electromagnetic waves. With the arrangement of FIGS. 1 and 2A through 2C, an interlayer insulation film 109 is arranged between the third conductor layer 106 and the fourth conductor layer 107. The third conductor layer 106 and the fourth conductor layer 107 are respectively electrically connected to the first conductor layer 104 and the second conductor layer 105. In FIGS. 1 and 2A through 2C, the first conductor layer 104 and the third conductor layer 106 are formed simultaneously and electrically connected to each other, and the second conductor layer 105 and the fourth conductor layer 107 are also formed simultaneously and electrically connected to each other. In the antenna section 102 arranged at the end facet of the resonator section 101, the third conductor layer and the fourth conductor layer has a matching area 110 where they are overlapped on each other in the above-described direction of stacking the layers. The matching area 110 has a width that is gradually reduced in the direction of extending from the resonator section 101 toward the antenna section 102. In other words, the matching area 110 has a profile that is tapered from the resonator section toward the antenna section as viewed in the direction of stacking the conductor layers.

Reflections of electromagnetic waves in the matching area 110 can be reduced to suppress attenuation of electromagnetic waves by gradually reducing the width of the matching area 110. The input impedance of the antenna section 102 can be adjusted by modifying the width 111 of the part of the matching area 110 that is held in contact with the resonator section 101. By so doing, the characteristic impedance of the resonator section 101 and the input impedance of the antenna section 102 can be made to be close to each other for impedance matching.

Immediately after being emitted from the resonator section 101, an electromagnetic wave has an electric field component in the film stacking direction (the direction perpendicular to FIG. 2A). As the electromagnetic wave passes through the matching area 110 and proceeds in the antenna section 102, the electric field is turned by 90° and the direction of polarization is shifted to an in-plane direction of FIG. 2A. A planar antenna that can easily be prepared by way of a semiconductor process can be provided by shifting the direction of polarization. In short, the antenna section 102 is a planar antenna in which the two conductor layers, or the third conductor layer and the fourth conductor layer, are formed as different layers. Alternatively, an oscillation device 100 that can efficiently utilize the electromagnetic wave in the resonator section 101 can be obtained by forming an antenna such as a tapered slot antenna for the antenna section 102 and establishing matching with the outside of the device such as a free space.

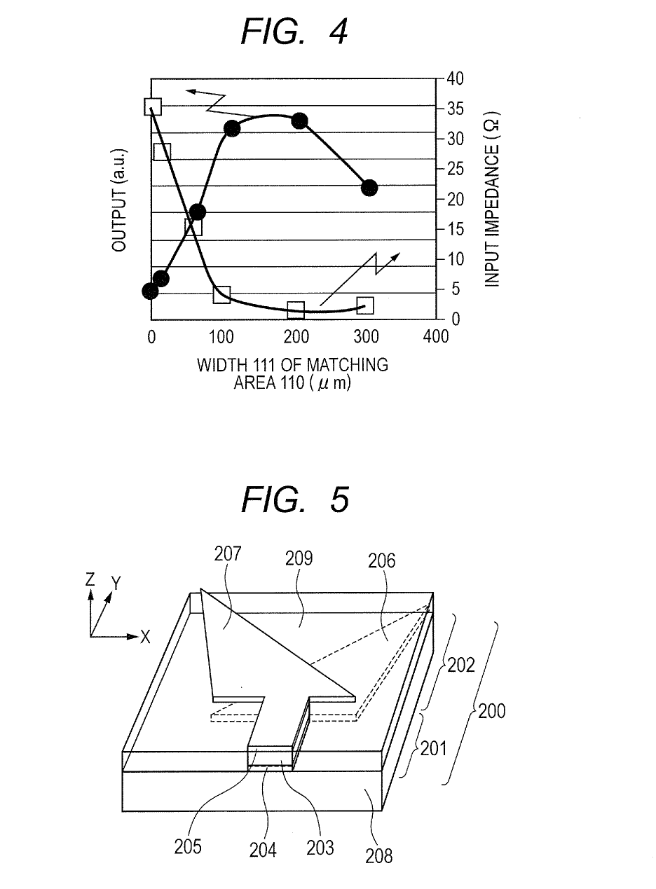

FIG. 4 illustrates the results obtained by computing the outputs of electromagnetic waves that are output by changing the width 111 of the matching area 110. HFSS available from ANSYS JAPAN employed for the computations. The structure and the materials same as those of the resonator section of Example 1 are used for the resonator section 101 and the width of an open end of the tapered slot antenna of 500 μm and a taper angle 112 of 20 degrees were employed for the arrangement by which the results of FIG. 4 are obtained. As will be described in greater detail in Example 1, the width of the resonator section 201 is 4 μm. Note that the taper angle 112, the ratio of the width of the resonator section 101 to the width 111 of the matching area 110 and the ratio of the width of the open end of the tapered slot antenna to the width 111 of the matching area 110 illustrated in FIG. 2A are made different from the actual values for the purpose of easy viewing (this notice also applies to other similar drawings). With the above-described arrangement, the characteristic impedance of the resonator section is as small as not greater than 1Ω and hence the width 111 of the matching area 110 for matching input impedance is preferably between 100 μm and about 200 μm. Since the resonator section 101 is made to have a Fabry-Perot resonator structure that makes an electromagnetic wave a standing wave by utilizing reflections from an end facet of the resonator, it is necessary that a perfect impedance matching cannot be established at the interface of the resonator section 101 and the matching area 110 and electromagnetic waves are partly reflected. Preferably, the first conductor layer 104, the second conductor layer 105, the third conductor layer 106 and the fourth conductor layer 107 are formed by using a highly electrically conductive material such as metal, semimetal or a densely doped semiconductor, or a conductive member formed by stacking materials selected appropriately from the above listed materials and hence containing some of the above listed materials.

The above arrangement may be appropriately modified so as to be operated as reception device. The antenna section 102 may be made to operate both as oscillation antenna and as reception antenna.

Such a reception device includes a resonator section for resonating electromagnetic waves and an antenna section arranged at an end facet of the resonator section and having a multilayer structure including two conductor layers for causing electromagnetic waves to enter the resonator section. Here again, the matching area has a tapered profile and its width is gradually reduced in the direction extending from the resonator section toward the antenna section as viewed in the direction of stacking the layers.

The profile of the matching area 110 is not necessarily limited to the linear ones illustrated in FIGS. 2A and 3A. Alternatively, the matching area 110 may have a curved profile as illustrated in FIG. 3B or a stepped profile, each step having a length of not greater than half of the wavelength of the electromagnetic wave λ/2, as illustrated in FIG. 3C. In short, the profile of the matching area 110 as viewed in the direction of stacking the layers is not necessarily limited to the above-described ones so long as the width of the matching area 110 is gradually reduced in the direction of extending from the resonator section 101 toward the antenna section 102. The expression of “gradually reduced” as used herein covers “monotonously and continuously gradually reduced”, “non-continuously reduced” and “gradually reduced but may sometimes be increased”.

While the portion of the matching area 110 that is sandwiched between the third conductor layer 106 and the fourth conductor layer 107 is formed by an interlayer insulation film 109 in FIGS. 1 and 2A through 2C, it may be replaced by a non-conductive member or formed by using a gain medium or an insulation layer such as a dielectric or a space. While the oppositely disposed two conductor layers are arranged in parallel with each other in FIGS. 1 and 2A through 2C, they may not necessarily be arranged in parallel. While the third conductor layer 106 and the fourth conductor layer 107 of the antenna section are drawn so as to be symmetric relative to the centerline of the resonator section extending from the resonator section toward the antenna section, they may not necessarily be arranged symmetrically. These conductor layers may be designed appropriately according to the requirements of preparation thereof and their specifications.

As described above, this embodiment of device is provided with a matching area extending toward the antenna section from the interface of the resonator section in which electromagnetic waves resonate and the antenna section from which electromagnetic waves are emitted or into which electromagnetic waves enter so as to suppress reflections of electromagnetic waves at the interface of the resonator section and the antenna section. In the matching area, the third conductor layer and the fourth conductor layer of the antenna section are laid one on the other in the direction of stacking the films by way of a gain medium or a dielectric. The input impedance of the antenna section can be adjusted by adjusting the size and the contour of the matching area and the characteristic impedance of the resonator section and the input impedance of the antenna section can be made to be close to each other for impedance matching. Furthermore, matching with the outside of the device such as a free space can be established by gradually reducing the width of the matching area in the extending direction thereof from the resonator section toward the antenna section and additionally forming an aperture antenna in the third conductor layer and the fourth conductor layer. In other words, an aperture antenna having an emission end for radiating electromagnetic waves into a free space can be so formed as to make the matching area of the antenna section represent a tapered profile with the width thereof being gradually reduced along the direction of propagation of electromagnetic waves so as to establish matching with the free space at the emission end. With such an arrangement, the number of required additional components such as silicon lenses can be reduced to by turn reduce the manufacturing cost. Furthermore, since a planar antenna structure can be adopted, the devices such as oscillation devices and reception devices that are mechanically stabilized and adapted to efficiently utilize electromagnetic waves can be produced by way of a simple manufacturing process.

Now, the present invention will be described more specifically by way examples.

### Example 1

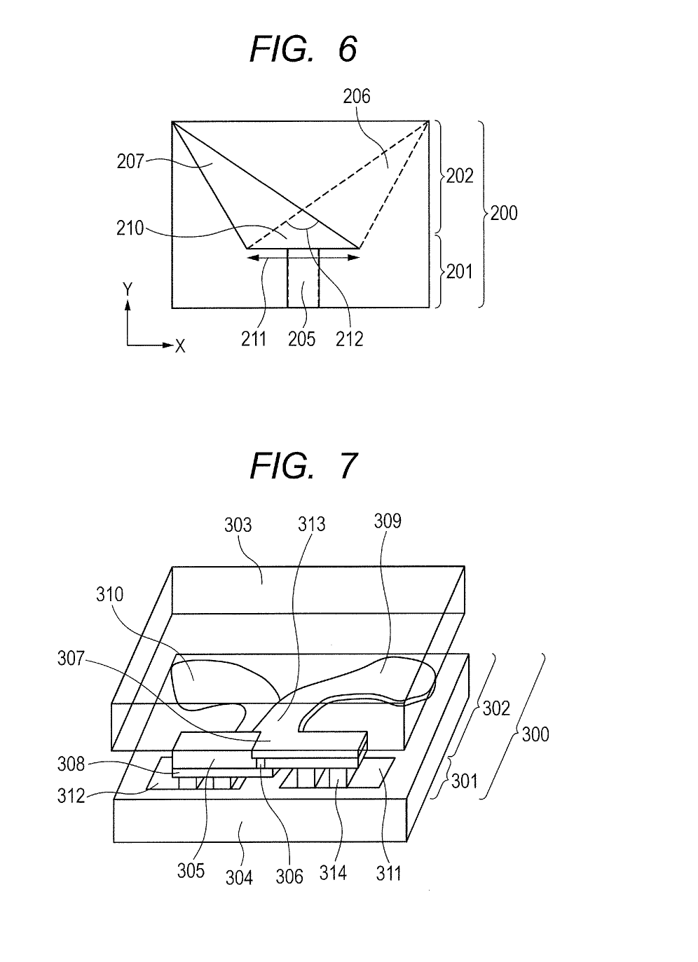

A specific example, or Example 1, of oscillation device according to the present invention will be described below by referring to FIGS. 5 and 6. FIG. 5 is a schematic perspective view of the oscillation device of this example and FIG. 6 is a top view thereof. In this example, a semiconductor multilayer structure including an InGaAs/InAlAs based triple barrier resonant tunneling diode (RTD) that generates terahertz waves by way of intersubband transitions is employed for active layer 203. The RTD structure is a semiconductor quantum well structure formed by sequentially laying n⁻InGaAs (thickness: 50 nm, Si, carrier concentration 2×10¹⁸ cm⁻³), InGaAs (5 nm), AlAs (1.3 nm), InGaAs (7.6 nm), InAlAs (2.6 nm), InGaAs (5.6 nm), AlAs (1.3 nm), InGaAs (5 nm) and n⁻InGaAs (50 nm, Si, 2×10¹⁸ cm⁻³) in the above mentioned order. The RTD structure is connected to the first conductor layer 204 and the second conductor layer 205 with a relatively low resistivity by the densely carrier-doped n⁺InGaAs (400 nm, 1×10¹⁸ cm⁻³) that are arranged on the top and under the bottom of the RTD structure.

In this example, the first conductor layer 204 and the third conductor layer 206 are formed simultaneously by using a multilayer film of Ti/Pd/Au/Pd/Ti (the thicknesses of the components=20 nm/20 nm/400 nm/20 nm/20 nm). Similarly, the second conductor layer 205 and the fourth conductor layer 207 are formed simultaneously by using a multilayer film of Ti/Pd/Au (the thicknesses of the components=20 nm/20 nm/400 nm). Substrate 208 is a semi-insulating GaAs substrate and is mechanically connected to the first conductor layer 204. Interlayer insulation film 209 can suitably be formed by using an insulating material that represents a low loss in the terahertz band (e.g., a resin material such as BCB or an inorganic material such as SiO₂). BCB (benzocyclobutene) is employed in this example. The oscillation device 200 is connected to a power source by way of wiring (not illustrated) connected to the first conductor layer 204 and the second conductor layer 205 and a bias voltage is supplied to the active layer 203 to drive the device.

Resonator section 201 has a Fabry-Perot resonator structure and is provided with at least two end-facets along the direction of propagation of electromagnetic waves. Electromagnetic waves are made to be standing waves by utilizing reflections at the end facets so that the length along the direction of propagation is the factor that determines the oscillation wavelength. In this example, the length and the width of the resonator section 201 are respectively made to be equal to 50 μm, which is ½ times of the guide wavelength λ_{g}, and 4 μm. The distance separating the first conductor layer 204 and the second conductor layer 205 in the direction of stacking the layers is about 1 μm. In other words, they are arranged close to each other. Differently stated, the first conductor layer and the second conductor layer of the resonator section are arranged close to each other with a distance separating them not greater than the guide wavelength of electromagnetic waves in a waveguide mode (guided mode) of the waveguide structure or in an oscillation mode of the oscillation device. The resonator section 201 is designed with an oscillation frequency of 0.2 THz and a guide wavelength λ_{g} of 100 μm. Electromagnetic waves propagate in the resonator section 201 in plasmon mode and the end facets of the resonator section 201 provide open ends. The oscillation device 200 emits an electromagnetic wave of 0.2 THz generated on the basis of a photon-assisted tunneling phenomenon in a negative differential resistance area from antenna section 202 arranged at an end of the resonator section 201.

Matching area 210 that extends from the interface of the antenna section 202 and the resonator section to attenuate reflections of electromagnetic waves is formed in the antenna section 202. In the matching area 210, the third conductor layer 206 and the fourth conductor layer 207 are laid one on the other in the direction of film growth by way of an interlayer insulation film 209. For the profile of the matching area 210 of this example, the width 211 of the part of the matching area 210 that is held in contact with the resonator section 201 and the taper angle 212 of the matching area 210 are respectively made equal to 100 μm and 20 degrees. The input impedance of the antenna section 202 can be adjusted and matching with the resonator section 201 can be established by modifying the width 211 of the above identified part. More specifically, the input impedance of the antenna section 202 can be reduced by increasing the width 211 of the matching area 210. Furthermore, matching with a free space can be established by gradually broadening the gap between the third conductor layer 206 and the fourth conductor layer 207 in the in-plane direction along the direction of propagation of electromagnetic waves. The antenna section 202 of this example has a tapered slot antenna structure and the width of its largest opening section is about 700 μm.

The method of preparing the oscillation device of this example typically includes the following steps. Firstly, a semi-insulating GaAs substrate is brought in as substrate 208 and metal layers of Ti/Pd/Au (thicknesses of the components=20 nm/20 nm/200 nm) are formed on the semi-insulating GaAs substrate by means of an evaporation system. Metal layers of Ti/Pd/Au (thicknesses of the components=20 nm/20 nm/200 nm) are formed on an InP substrate, on which an RTD structure and a densely carrier-doped n-InGaAs that is epitaxially grown are formed in advance, also by means of an evaporation system. The InP substrate and the substrate 208 are bonded together by means of Au thermal compression bonding with the top surfaces of the substrates directly facing each other. The first conductor layer 204 and the third conductor layer 206 are produced as the Ti/Pd/Au/Pd/Ti (thicknesses of the components=20 nm/20 nm/400 nm/20 nm/20 nm) formed by the bonding are processed in a step that will be described hereinafter. The InP substrate is removed from the integrally bonded substrates by hydrochloric acid etching and the semiconductor layer is transferred onto the substrate 208. Then, the semiconductor layer is processed to make it represent a profile of a waveguide by photolithography and dry etching to produce the active layer 203. Additionally, the Ti/Pd/Au/Pd/Ti that is formed by compression bonding is processed by photolithography and dry etching to produce the first conductor layer 204 and the third conductor layer 206. The structure of the active layer 203 is buried by means of the interlayer insulation film 209 by spin coating and the top part of the active layer 203 is exposed by dry etching. The interlayer insulation film is formed by using BCB. Then, the second conductor layer 205 and the fourth conductor layer 207 that are made of Ti/Pd/Au (thicknesses of the components=20 mm/20 nm/200 nm) are formed by means of vacuum evaporation and lift off techniques.

As a result, oscillation devices and any others adapted to utilize electromagnetic waves can be formed by way of a simple manufacturing process without using additional components such as silicon lenses. Additionally, matching between a resonator (resonator section) and an antenna section can be designed and established with ease.

The present invention is by no means limited to the above-described arrangements. For instance, the active layer 203 is described above for this example in terms of a triple barrier resonant tunneling diode based on InGaAs/InAlAs or InGaAs/AlAs grown on an InP substrate. However, a waveguide that can be used for an oscillation device and any others according to the present invention can be provided by using some other structure and some other combination of materials instead of the above-described structure and materials. For example, a resonant tunneling diode having a double barrier quantum well structure, a resonant tunneling diode having a quadruple or higher barrier quantum well structure, a multiple quantum well structure having cascade connections as is known by a quantum cascade laser, or the like may also be employed. In the case of an oscillation device 200 formed by using an RTD, the width 211 of the matching area 210 is inevitably broad because the gap separating the two conductor layers of the resonator section 201 is small and hence the characteristic impedance thereof is small. On the other hand, when the resonator section 201 is formed by using a quantum cascade laser, the gap separating the two conductor layers of the resonator section 201 is large and hence the characteristic impedance thereof is large so that the width 211 of the matching area 210 becomes smaller if compared with the instance where an RTD is employed for the resonator section.

Any of the above-described structures and materials may be appropriately selected according to the desired frequency of electromagnetic waves and other factors. The material of the substrate 208 may also be appropriately selected according to the application of the oscillation device. Examples of substrates include semiconductor substrates such as high resistivity silicon substrates, semi-insulating gallium arsenide substrates, semi-insulating indium arsenide substrates and semi-insulating gallium phosphide substrates, glass substrates, ceramic substrates and resin substrates. Examples of materials that can suitably be used for the interlayer insulation film 209 include inorganic materials such as SiO₂, polysilicon, SiNₓ, AlN and TiO₂ and organic materials such as BCB (benzocyclobutene), SU-8 and polyimide. Materials obtained by regrowth of low-conductive intrinsic semiconductor may also be used. A V-shaped antenna, a rhombic antenna, a tapered slot antenna or a Vivaldi antenna may suitably be used for the antenna section 202.

### Example 2

Now, oscillation device 300 of Example 2 of the present invention will be described below by referring to FIG. 7. FIG. 7 is a schematic perspective view of the device. An RTD structure same as that of Example 1 is employed for the resonator section 301 formed on the first substrate 303. The component materials are same as those of Example 1 except the substrate and the manufacturing method of this example is also same as that of Example 1 down to preparation of the resonator section 301. Both the first substrate 303 and the second substrate 304 are high resistivity silicon substrates. However, as described above for Example 1, the material of the substrates is not limited to silicon and any other material may be used for them provided that the material is selected from semiconductor materials, dielectric materials and insulating materials. Thereafter, the structure of the active layer 306 is buried by means of the interlayer insulation film 305 and the top part of the active layer 306 is exposed by dry etching. Then, the second conductor layer 308 is formed. As in Example 1, the third conductor layer 309 of the antenna section 302 and the first conductor layer 307 of the resonator section are formed simultaneously. The pattern of the fourth conductor layer 310 of the antenna section 302 also operates as the second bonding electrode 312. The fourth conductor layer 310 and first bonding electrode 311 are formed simultaneously. Bonding gold bumps 314 are formed respectively on the first bonding electrode 311 and the second bonding electrode 312 and the first substrate 303 and the second electrode 304 are arranged vis-a-vis and bonded to each other. In this way, the first substrate, the third conductor layer which is one of the two conductor layers, the interlayer insulation film, the fourth conductor layer that is the other one of the two conductor layers and the second substrate are sequentially laid one on the other in the abovementioned order to construct the antenna section.

In the matching area 313 of this example, the third conductor layer 309 and the fourth conductor layer 310 overlap each other with the atmosphere interposed between them. Since the antenna section 302 of this example has a Vivaldi antenna structure, the matching are 313 is made to represent a curved profile as illustrated in FIG. 3B and the width of the matching area 313 is gradually reduced in the extending direction thereof from the resonator section 301 toward the antenna section 302. With this structure, since the substrates are arranged above and below the antenna section, the antenna section can radiate an electromagnetic wave symmetrically upward and downward unlike an instance where a substrate is arranged at a side of the antenna section. Additionally, matching between the resonator (resonator section) and an antenna section can be designed and established with ease.

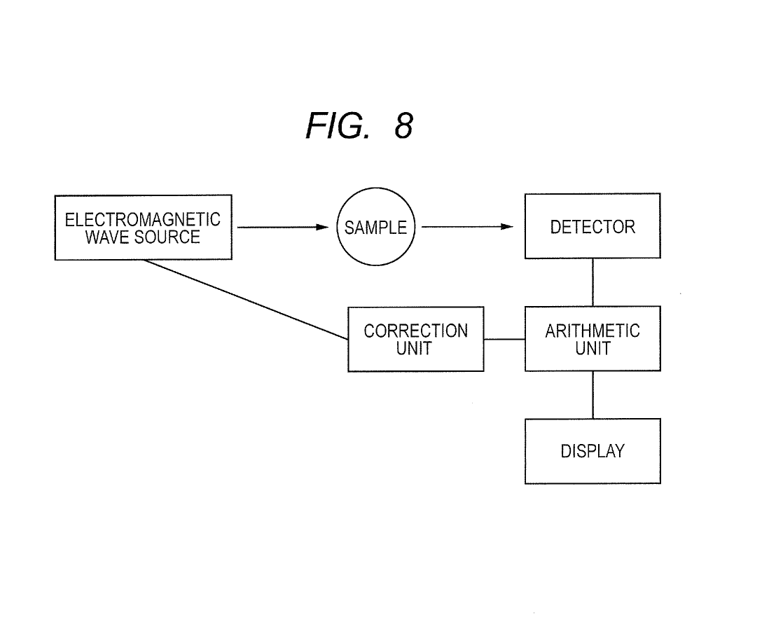

According to the present invention, an apparatus as illustrated in FIG. 8 can be provided by using a device having the above-described configuration in combination with an arithmetic unit for computationally determining the condition of a sample. For example, an oscillation device according to the present invention as described above is employed as electromagnetic wave source for generating electromagnetic waves and a sample is arranged at an end of the electromagnetic wave source. Since the sample interacts with the electromagnetic wave oscillated and emitted from the electromagnetic wave source, the oscillated electromagnetic wave is influenced by the sample to a certain extent. The electromagnetic wave irradiated onto the sample is reflected or transmitted and the reflected or transmitted electromagnetic wave is detected by a detector. A reception device as described above can be used as detector. Thereafter, information (the condition etc.) on the sample is computationally determined from a detected signal by means of an arithmetic unit, which may be a personal computer. More specifically, applications to industrial examination apparatus for examining the conditions of drugs are conceivable. The information on the sample computationally determined by the arithmetic unit may be displayed on a display. The information on the sample computationally determined by the arithmetic unit may be corrected by means of a correction unit, using information from the electromagnetic wave source. A measurement apparatus (sample information acquisition apparatus) that detects the electromagnetic wave emitted from an oscillation device, irradiated on a sample and subsequently reflected by or transmitted through the sample to get to the apparatus by means of a reception device can be formed. In such an apparatus, at least either the oscillation device or the reception device is an oscillation device or a reception device, whichever appropriate, according to the present invention and detects the electromagnetic wave that has interacted with the sample or acquires information on the sample from the detected signal.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-108683, filed May 10, 2012, which is hereby incorporated by reference herein in its entirety.

1. An oscillation device for electromagnetic wave oscillation comprising:
a resonator section that causes an electromagnetic wave to resonate; and
an antenna section that is arranged at an end facet of the resonator section and has a multilayer structure including two conductor layers for causing the electromagnetic wave to be emitted from the resonator section,
the two conductor layers being separated from each other by a gap in the stacking direction of the multilayer structure and having at least partly overlapping matching area for impedance matching,
the matching area having a width that is gradually reduced in the direction of extending from the resonator section toward the antenna section as viewed in the stacking direction.

2. The oscillation device according to claim 1, wherein
the resonator section is formed by laying a first conductor layer, a gain medium having a gain relative to an electromagnetic wave and a second conductor layer in the above mentioned order; and
the two conductor layers of the antenna section at least partly overlap each other to form the matching area with a gain medium or an insulator interposed between them.

3. The oscillation device according to claim 2, wherein
the first conductor layer and the second conductor layer of the resonator section form a plasmon waveguide structure of which the real part of dielectric constant includes a negative dielectric constant medium.

4. The oscillation device according to claim 2, wherein
the first conductor layer and the second conductor layer of the resonator section are arranged close to each other with a distance separating them not greater than the guide wavelength of the electromagnetic wave in a waveguide mode of the plasmon waveguide structure or in an oscillation mode of the oscillation device.

5. The oscillation device according to claim 1, wherein
the resonator section is formed so as to include a multiple quantum well structure that generates terahertz waves by way of intersubband transitions of carriers.

6. The oscillation device according to claim 2, wherein
the first conductor layer and the third conductor layer that is one of the two conductor layers are electrically connected to each other and the second conductor layer and the fourth conductor layer that is the other one of the two conductor layers are electrically connected to each other.

7. The oscillation device according to claim 1, wherein
the matching area is so formed as to make the input impedance of the antenna section and the characteristic impedance of the resonator section to be close to each other.

8. The oscillation device according to claim 1, wherein
the oscillation device has an emission end for radiating the electromagnetic wave oscillated in the oscillation device into a free space; and
the antenna section is an aperture antenna formed so as to make the matching area of the antenna section represent a profile with the width thereof being gradually reduced along the direction of propagation of electromagnetic waves so as to establish matching with the free space at the emission end.

9. The oscillation device according to claim 1, wherein
the antenna section is a planar antenna in which the two conductor layers, or the third conductor layer and the fourth conductor layer, are formed as different layers.

10. The oscillation device according to claim 1, wherein
the antenna section is formed by sequentially laying a first substrate, the third conductor layer which is one of the two conductor layers, an interlayer insulation film, the fourth conductor layer which is the other one of the two conductor layers and a second substrate one on the other in the above mentioned order.

11. The oscillation device according to claim 1, wherein
the electromagnetic wave is an electromagnetic wave in a frequency range not less than 30 GHz and not more than 30 THz.

12. A reception device for electromagnetic wave reception comprising:
a resonator section that causes an electromagnetic wave to resonate; and
an antenna section that is arranged at an end facet of the resonator section and has a multilayer structure including two conductor layers for causing the electromagnetic wave to enter the resonator section,
the two conductor layers being separated from each other by a gap in the stacking direction of the multilayer structure and having at least partly overlapping matching area for impedance matching,
the matching area having a width that is gradually reduced in the direction of extending from the resonator section toward the antenna section as viewed in the stacking direction.

13. A sample information acquisition apparatus for acquisition of information on a sample, the apparatus comprising:
an electromagnetic wave source that generates an electromagnetic wave; and
a detector that detects the electromagnetic wave after interaction thereof with the sample,
the electromagnetic wave source having an oscillation device according to claim 1.

14. A sample information acquisition apparatus for acquisition of information on a sample, the apparatus comprising:
an electromagnetic wave source that generates an electromagnetic wave; and
a detector that detects the electromagnetic wave after interaction thereof with the sample,
the detector having a reception device according to claim 12.
